(19) United States
(12) Patent Application Publication
(10) Pub. No.: US 2015/0237406 A1
(43) Pub. Date: Aug. 20, 2015

(54) CHANNEL NAVIGATION IN CONNECTED MEDIA DEVICES THROUGH KEYWORD SELECTION

(71) Applicants: Claudio J. Ochoa, Villa Allende (CBA) (AR); Stanley Mo, Portland, OR (US); Victor Szilagyi, London (GB); Elliot Smith, Northfield (GB); Gustavo D. Domingo Yaguez, Cordoba (AR)

(72) Inventors: Claudio J. Ochoa, Villa Allende (CBA) (AR); Stanley Mo, Portland, OR (US); Victor Szilagyi, London (GB); Elliot Smith, Northfield (GB); Gustavo D. Domingo Yaguez, Cordoba (AR)

(21) Appl. No.: 13/997,382

(22) PCT Filed: Dec. 13, 2011
(86) PCT No.: PCT/US11/64574

§ 371 Date: Feb. 20, 2015

(51) Int. Cl. H04N 21/482; H04N 21/431; H04N 21/472; H04N 21/8405

(52) U.S. Cl. CPC H04N 21/4828; H04N 21/8405; H04N 21/431; H04N 21/472

(57) ABSTRACT

Methods and systems may include logic to receive a query for one or more channel suggestions, and search a database in response to the query, wherein the database includes keyword data associated with a plurality of display devices. The logic may also generate a list of channel suggestions based on the search.

### BACKGROUND

1. Technical Field

Embodiments generally relate to media content. More particularly, embodiments relate to the use of keywords to navigate through channels of media content.

2. Discussion

Traditionally, end-users may search for television (TV) programs by reading a printed guide and navigating to channels of interest, or by scanning through multiple channels listed in an electronic program guide (EPG) until a program of interest is encountered. While these approaches may be suitable raider certain circumstances, there remains considerable room for improvement.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1A is a block diagram of an example of a keyword sharing architecture according to an embodiment;

FIG. 1B is a block diagram of an example of a channel navigation user interface according to an embodiment.

FIG. 2 is a listing of an example of information associated with media content according to an embodiment;

FIG. 3 is a flowchart of an example of a method of generating channel suggestions according to an embodiment;

FIG. 4 is a flowchart of an example of a method of requesting channel suggestions according to an embodiment; and

FIG. 5 is a flowchart of an example of a system according to an embodiment.

### DETAILED DESCRIPTION

Embodiments may include at least one computer accessible storage medium having a set of instructions which, if executed by a processor, cause a computer to identify a content keyword associated with a display device, and generate a query for one or more channel suggestions based on the content keyword. The instructions may also cause a computer to send the query to a cloud service.

Additionally, embodiments may include at least one computer accessible storage medium having a set of instructions which, if executed by a processor, cause a computer to receive a query for one or more channel suggestions, and search a database in response to the query. The database may include keyword data associated with a plurality of media devices. The instructions may also cause a computer to generate a list of channel suggestions based on the search.

Other embodiments may include a system having a network interface, a query module configured to receive a query for one or more channel suggestions via the network interface. The system may also include a keyword module configured to search a database in response to the query, wherein the database is to include keyword data associated with a plurality of media devices. Moreover, the system may include a suggestion module configured to generate a list of channel suggestions based on the search.

In addition, embodiments may include an apparatus having logic to receive a first set of keyword data associated with a first media device, and receive a second set of keyword data associated with a second media device. The logic may also add the first set of keyword data and the second set of keyword data to a database, wherein the first set of keyword data and the second set of keyword data include content keywords and one or more of channel identifiers, network identifiers, contextual content and timestamps. Additionally, the logic may receive a query for one or more channel suggestions, extract a keyword from the query, and use the extracted keyword to search the database in response to the query. The logic may also generate a list of channel suggestions based on the search, and use one or more of the content keywords, the channel identifiers, the network identifiers, the contextual content and the timestamps to filter the list of channel suggestions. In addition, the logic may use one or more of the content keywords, the channel identifiers, the network identifiers, the contextual content and the timestamps to sort the list of channel suggestions.

Embodiments may also include a computer implemented method that includes receiving a first set of keyword data associated with a first media device, receiving a second set of keyword data associated with a second media device, and adding the first set of keyword data and the second set of keyword data to a database, wherein the first set of keyword data and the second set of keyword data include content keywords and one or more of channel identifiers, network identifiers, contextual content and timestamps. The method may also provide for receiving a query for one or mote channel suggestions, extracting a keyword from the query, and using the extracted keyword to search the database in response to the query. In addition, the method may involve generating a list of channel suggestions based on the search, and using one or more of the content keywords, the channel identifiers, the network identifiers, the contextual content and the timestamps to filter the list of channel suggestions. Moreover, one or more of the content keywords, the channel identifiers, the network identifiers, the contextual content and the timestamps may be used to sort the list of channel suggestions.

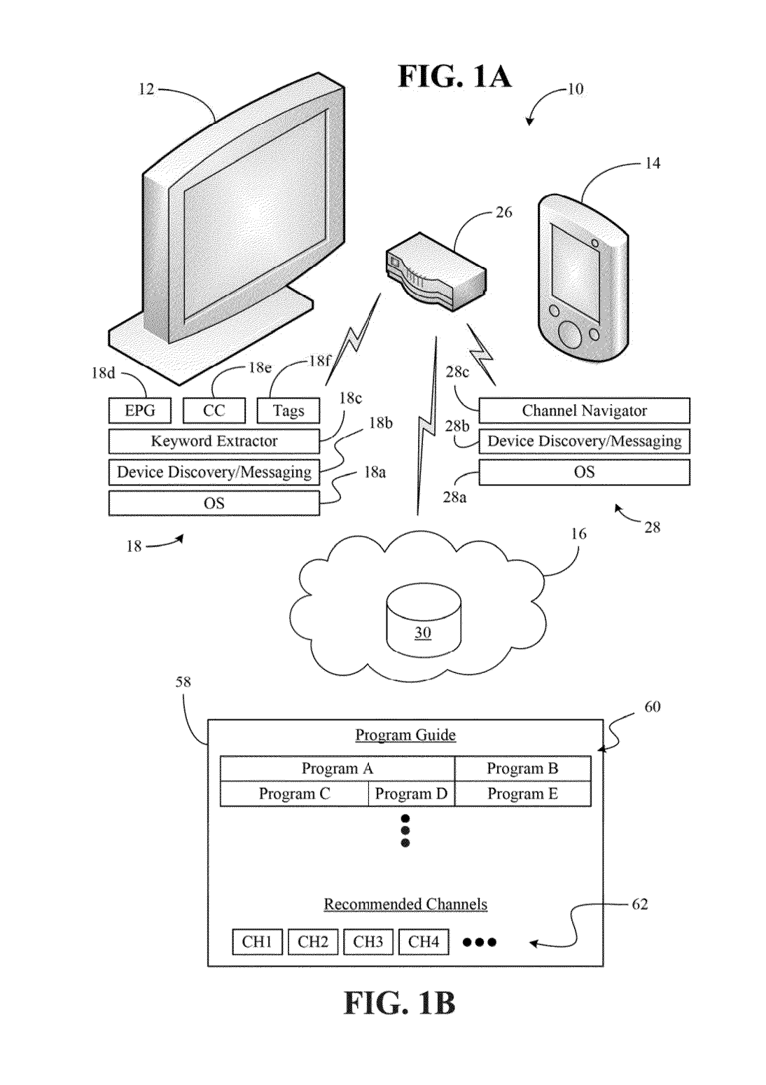

Turning now to FIG. 1A, an architecture 10 is shown in which a media device such as a display device 12 is used (e.g., by one or more individuals, not shown) to experience, view and/or listen to media content such as broadcast content (e.g., TV, radio), social networking content (e.g., Facebook chat and/or feed, Twitter feed), video streams (e.g., Internet-based), audio streams (e.g., Internet-based), and so forth. Thus, the media device may include a laptop, personal digital assistant (PDA), wireless smart phone, media player, imaging device, mobile Internet device (MID), any smart device such as a smart phone, smart tablet, and so forth, or any combination thereof. In addition, the media device may include a smart TV, personal computer (PC), server, workstation, liquid crystal display (LCD), light emitting diode (LED) display, etc. In the illustrated example, a companion device 14 is used to navigate to various channels of media content on the display device 12, wherein the companion device may be a laptop, PDA, wireless smart phone, media player, imaging device, MID, any smart device such as a smart phone, smart tablet, and so forth. The companion device 14 may also be used to obtain one or more channel suggestions from a cloud service 16 in real-time.

In particular, the display device 12 may include a software stack 18 (18a-18f) that has an operating system (OS) layer 18a that may be based on, for example, Windows, Mac, Linux technology, or another OS technology, and a device discovery and messaging layer 18b above the OS layer 18a, wherein the discovery and messaging layer 18b may be based on, for example, XMPP (Extensible Messaging and Presence Protocol, Internet Engineering Task Force), uPNP (Universal Plug and Play, International Organization for Standardization (ISO) and the International Electrotechnical Commission (IEC)), DLNA (Digital Living Network Alliance) technology, or another protocol. A keyword extractor layer 18c may reside above the discovery and messaging layer 18b, wherein the keyword extractor layer 18c may identify one or more content keywords associated with the media content being experienced via the display device 12. As will be discussed in greater detail, the identification of content keywords may involve extracting the content keywords from static information such as information contained in an EPG 18d, or extracting the content keywords from dynamic information such as closed caption (CC) information 18e (e.g., embedded text, subtitles, etc.) or tag information 18f (e.g., video annotation information). In one example, the illustrated tag information 18f is extracted from HTML5 (Hypertext Markup Language 5) content.

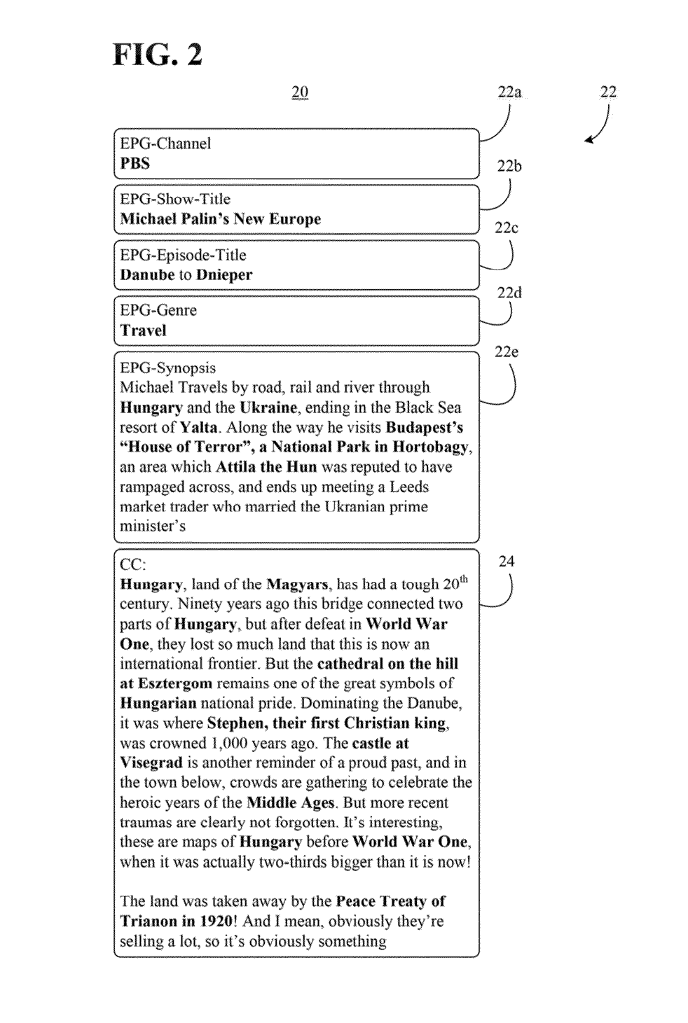

For example, FIG. 2 demonstrates that a listing 20 of textual content associated with a program entitled “Michael Palin's New Europe”, may include static EPG information 22 (22a-22e) having a channel component 22a, a show title component 22b, an episode title component 22c, a genre component 22d, a synopsis component 22′e, and so forth, wherein the EPG information 22 may be used to extract metadata that defines one or more content keywords. In addition, the illustrated listing 20 includes dynamic CC information 24 that may also be used to extract metadata and/or identify content keywords.

One approach, for example, may be to use the channel identifier (e.g., PBS) and/or genre (e.g., Travel) as keywords. Additionally, proper nouns (e.g., Hungary), chaining consecutive proper norms (e.g. World War One), or proper nouns separated by prepositions (e.g., Peace Treaty of Trianon) may be flagged as relevant keywords in the EPG information 22 and CC information 24. More sophisticated algorithms include, but are not limited to, consulting a database of places and famous names, looking for repeating phrases, ranking higher those words that appear in the Show Title, Episode Title and Synopsis in the EPG, and learning from user behavior.

The learning may be conducted in real-time as the user selects items to read or interact with, wherein those decisions may generate coefficients or modifiers that impact the search and selection processes. The coefficient/modifier information may also be obtained from other or previous sources, as well as from contextual information about the user. For example, calendars, previous destinations (e.g., navigation information), user selections not related to the current activity (e.g., specific TV-companion device interaction currently underway), and other historical user preference data may ail be used to learn the user's behavior. The learning process may also be impacted by who else is on the user network. For instance, the presence of a friend or business colleague versus a child or spouse may impact the person's decisions and what should be brought to their attention. Other influences include, but are not limited to, social networking (e.g., Facebook) and other interactions. Simply put, the contextual content associated with the learning process may also serve as a source for content keywords.

Moreover, a timestamp (e.g., yyyy-MM-ddThh:mm:ss:frm—year, month, date, hour, minute, second, frame, etc.) may be associated with each content keyword, wherein the timestamp may identify when the particular keyword was encountered, on the media device. In addition, other related information, such as network identifiers may be flagged as content keywords to characterize the media in question. As will be discussed in greater detail, the content keywords may alternatively be obtained from direct user input.

Returning now to FIG. 1A, the content keywords may be transferred from the display device 12 to the companion device 14 via a router 26 (e.g., wired or wireless) using the protocol associated with the discovery and messaging layer 18b. In one example, the protocol is a chat protocol. The illustrated companion device 14 includes a software stack 28 (28a-28c) that includes an OS layer 28a, a discovery and messaging layer 28b and a channel navigation layer 28c. In general, the companion device 14 and/or the display device 12 may transmit the identified content keywords to the cloud service 16 for inclusion in a database 30. Additionally, the channel navigation layer 28c may generate queries for channel suggestions based on the content keywords, and send the queries to the cloud service 16. The illustrated cloud service 16, which maintains the database 30 based on content keywords from multiple media devices, may search the database in response to queries from any connected device, and return lists of channel suggestions based on the searches. In one example, the cloud service 16 is implemented as a REST (“REpresentative State Transfer”) service.

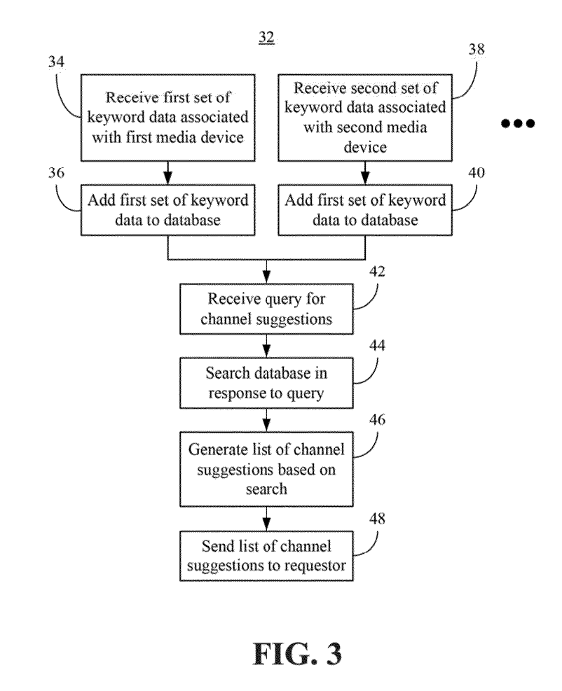

For example, FIG. 3 shows a method 32 of generating channel suggestions. The method 32 may be implemented in a cloud service such as the cloud service 16 (FIG. 1A) as a set of executable logic instructions stored in at least one machine- or computer-readable storage medium such as random access memory (RAM), read only memory (ROM), programmable ROM (PROM), flash memory, firmware, microcode, etc., in configurable logic such as programmable logic arrays (PLAs), field programmable gate arrays (FPGAs), complex programmable logic devices (CPLDs), in fixed-functionality hardware using circuit technology such as application specific integrated circuit (ASIC), complementary metal oxide semiconductor (CMOS) or transistor-transistor logic (TTL) technology, or any combination thereof. For example, computer program code to carry out operations shown in the method 32 may be written in any combination of one or more programming languages, including an object oriented programming language such as C++ or the like and conventional procedural programming languages, such as the “C” programming language or similar programming languages. Moreover, various aspects of the method 32 could be implemented as embedded logic of a processor using any of the aforementioned circuit technologies.

Illustrated processing block 34 provides for receiving a first set of keyword data associated with a first media device, wherein the first set of keyword data may be added to a database at block 36. As already noted, the keyword data may include, for example, one or more content keywords, channel identifiers, network identifiers, and timestamps. For example, the first set of keyword data, which may be contained within a channel suggestion query or transmitted separately from a query, could be related to a broadcast television sporting event (e.g., soccer game between a Hungarian team and a French team). Similarly, block 38 may receive a second set of keyword data associated with a second media device, wherein the second set of keyword data may be added to the database at block 40. For example, the second set of keyword data could be related to a currently streaming audio program about the Hungarian political process. The illustrated receiving and adding blocks may be repeated for many different media devices and/or their companion devices.

A query for channel suggestions may be received at block 42, wherein the query may be used to populate the database as well as to search the database at block 44. In particular, block 44 may involve extracting one or more keywords from the query and using the extracted keywords to search the database in response to the query. For example, with regard to the listing 20 (FIG. 2) discussed above, the query could contain the keyword “Hungary”, wherein block 44 may search the database for other entries (e.g., originating from other media devices) containing the keyword “Hungary”. Thus, in the above example, the search could return entries about the televised Hungarian soccer game and/or the streamed audio program about Hungarian politics.

Illustrated block 46 generates a list of channel suggestions based on the search, wherein the database entry keywords, channel identifiers, network identifiers, timestamps, etc., may be used to filter the list of channel suggestions. For example, a filter may be instituted to restrict the suggestion results to certain genres (e.g., sports, travel), networks (e.g., particular satellite TV provider, Internet streams), or channels (e.g., HGTV, ESPN). Additionally, a time-based filter could be deployed so that stale entries (e.g., more than thirty minutes old) are removed from the list of channel suggestions. Moreover, the filter may be customizable by the user, system wide, demographic based, etc., or any combination thereof. The database entry keywords, channel identifiers, network identifiers, timestamps, etc., may also be used to sort the list of channel suggestions. For example, the list may be sorted by timestamp in order to present the user with channel suggestions that are based on the most recent content keywords. Such an approach may provide the end-user with the most timely channel suggestions. Block 48 may send the list of channel suggestions to the requestor, wherein the requestor may be a media device or a companion device associated with a media device.

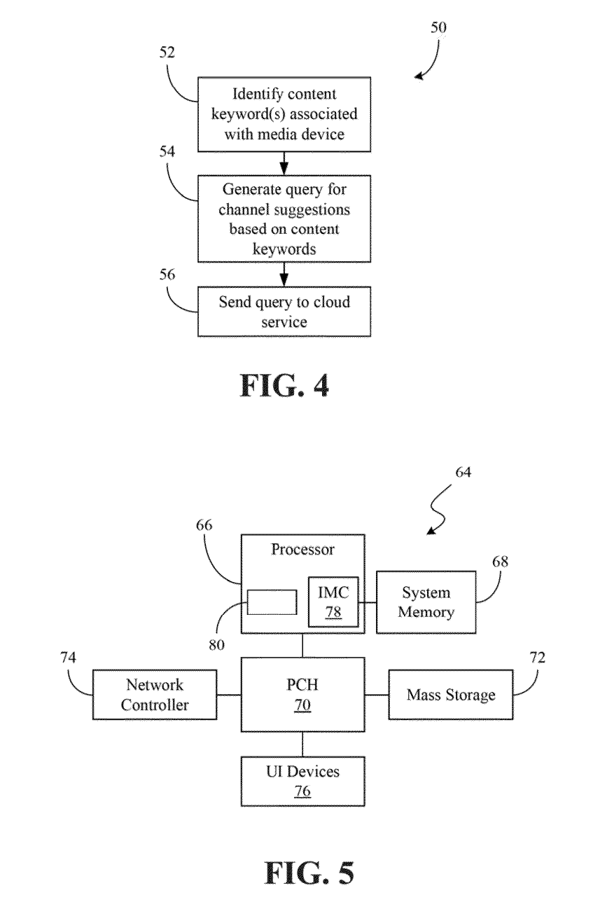

FIG. 4 shows a method 50 of requesting channel suggestions. The method 50 may be implemented in a media device such as the display device 12 (FIG. 1A) and/or a companion device such as the companion device 14 (FIG. 1A) as a set of executable logic instructions stored in at least one machine- or computer-readable storage medium such as RAM, ROM, PROM, flash memory, firmware, microcode, etc., in configurable logic such as, for example, PLAs, FPGAs, CPLDs, in fixed-functionality hardware using circuit technology such as, for example, ASIC, CMOS or TTL technology, or any combination thereof. For example, computer program code to carry out operations shown in the method 50 may be written in any combination of one or more programming languages, including, for example, an object oriented programming language such as C++ or the like and conventional procedural programming languages, such as the “C” programming language or similar programming languages. Moreover, various aspects of the method 50 could be implemented as embedded logic of a processor using any of the aforementioned circuit technologies.

Illustrated processing block 52 provides for identifying one or more content keywords associated with a media device. As already noted, one approach to identifying the content keywords is to use a keyword extractor such as the keyword extractor layer 18c (FIG. 1A) to extract the keyword content from dynamic information and/or static information of a program, wherein the program may be associated with a broadcast channel, a social networking channel, a video stream, an audio stream, and so forth. Alternatively, user input may be received via a user interface (UI), wherein the content keywords are identified based on the user input. For example, the user of a companion device may enter an actor's name, the name of a place, dialog, a genre, etc., of a program being experienced on a media device. In such a case, the entered information may be used to generate a query for channel suggestions at block 54. The query may be sent to the cloud service at block 56.

Turning now to FIG. 1B, a UI 58 is shown. The illustrated UI 58 may be incorporated into the channel navigation layer 28c (FIG. 1A) of a companion device and/or media device in order to enhance the media experience of a user. In particular, the UI 58 may include a program guide 60 that contains information about various programs (e.g., Programs “A” to “E”). The UI 58 may also include a recommendation section 62 that includes channel recommendations (e.g., “CH1” to “CH4”) that are obtained from a cloud service such as the cloud service 16 (FIG. 1A), already discussed. Thus, the illustrated channel recommendations may be generated based on keyword data obtained from a plurality of remote media devices through the query process discussed above, wherein selecting one or more of the channel suggestions may cause the media device to automatically navigate to the selected channel.

FIG. 5 shows a computing platform 64 having a processor 66, system memory 68, a platform controller hub (PCH) 70, mass storage (e.g., hard disk drive/HDD, optical disk, flash memory) 72, a network interface/controller 74, one or more user interface (UI) devices 76 and various other controllers (not shown). The platform 64 may be part of, for example, a personal computer (PC), server, workstation, etc. Indeed, the platform 64 may be partially or totally incorporated into one or more computing platforms of a cloud service such as the cloud service 16 (FIG. 1A), already discussed. Thus, the processor 66 may include one or more processor cores capable of executing a set of stored logic instructions, and an integrated memory controller (IMC) 78 configured to communicate with the system memory 68. The system memory 68 may include, for example, dynamic random access memory (DRAM) configured as a memory module such as, for example, a dual inline memory module (DIMM), a small outline DIMM (SODIMM), etc.

In the illustrated example, the processor 66 is configured to execute logic 80 that receives keyword data associated with a plurality of media devices via the network controller 74, adds the keyword data to a database, receives one or more queries for channel suggestions via the network controller 74, searches the database in response to the queries, generates channel suggestions based on the search, and sends the channel suggestions to the originators of the queries via the network controller 74. Thus, the logic 80 may implement one or more aspects of the method 32 (FIG. 3), already discussed.

The illustrated PCH 70, sometimes referred to as a Southbridge of a chipset, functions as a host device and may communicate with the network controller 74, which could provide off-platform wireless communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), Wi-Fi (Wireless Fidelity, e.g., institute of Electrical and Electronics Engineers/IEEE 802.11-2007, Wireless Local Area Network/LAN Medium Access Control (MAC) and Physical Layer (PHY) Specifications), LR-WPAN (Low-Rate Wireless Personal Area Network, e.g., IEEE 802.15.4-2006), Bluetooth (e.g., IEEE 802.15.1-2005, Wireless Personal Area Networks), WiMax (e.g., IEEE 802.16-2004, LAN/MAN Broadband Wireless LANS), GPS (Global Positioning System), spread spectrum (e.g., 900 MHz), and other RF (radio frequency) telephony purposes. The network controller 74 may also provide off-platform wired communication (e.g., RS-232 (Electronic Industries Alliance/EIA), Ethernet (e.g., IEEE 802.3-2005), power line communication (e.g., X10, IEEE P1675), USB (e.g., Universal Serial Bus, e.g., USB Specification 3.0, Rev. 1.0, Nov. 12, 2008, USB Implementers Forum), DSL (digital subscriber line), cable modem, T1 connection, etc., functionality. The UI (e.g., touch screen, liquid crystal display/LCD, light emitting diode/LED, keyboard, mouse, etc.) devices 76 may be capable of enabling a user to interact with and perceive information from the platform 64.

Thus, embodiments may use dynamic keywords to build up a navigation list for channel selection, associate timestamps and channel/network codes with those keywords, and centralize the information into a cloud repository. Such an approach may obviate any need for a second tuner to conduct scans for programs of interest, and can significantly enhance the media experience from the perspective of the user. In addition, the “hottest” keywords may be used to advertise products and/or services, wherein the most popular channels may be available in real-time.

Certain aspects of embodiments of the present invention may be implemented using hardware, software, or a combination thereof and may be implemented in one or more computer systems or other processing systems. Program code may be applied to the data entered using an input device to perform the functions described and to generate output information. The output information may be applied to one or more output devices. One of ordinary skill in the art may appreciate that embodiments may be practiced with various computer system configurations, including multiprocessor systems, minicomputers, mainframe computers, and the like. Embodiments may also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the methods described herein. Alternatively, the methods may be performed by specific hardware components that contain hardwired logic for perforating the methods, or by any combination of programmed computer components and custom hardware components. The methods described herein may be provided as a computer program product that may include at least one machine readable medium having stored thereon instructions that may be used to program a processing system or other electronic device to perform the methods. The term “machine readable medium” or “machine accessible medium” used herein shall include any medium that is capable of storing or encoding a sequence of instructions for execution by the machine and that causes the machine to perform any one of the methods described herein. The terms “machine readable medium” and “machine accessible medium” may accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform as action or produce a result.

The term, “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

1-33. (canceled)

34. An apparatus comprising:
logic to,
receive a first set of keyword data associated with a first media device,
receive a second set of keyword data associated with a second media device,
add the first set of keyword data and the second set of keyword data to a database, wherein the first set of keyword data and the second set of keyword data include content keywords and at least one of channel identifiers, network identifiers, contextual content and timestamps,
receive a query for one or more channel suggestions,
extract a keyword from the query,
use the extracted keyword to search the database in response to the query,
generate a list of channel suggestions based on the search,
use at least one of the content keywords, the channel identifiers, the network identifiers, the contextual content and the timestamps to filter the list of channel suggestions; and
use at least one of the content keywords, the channel identifiers, the network identifiers, the contextual content and the timestamps to sort the list of channel suggestions.

35. The apparatus of claim 34, wherein the query is to be received from a media device, and wherein the logic is to send the list of channel suggestions to the media device.

36. The apparatus of claim 34, wherein the query is to be received from a companion device associated with a media device, and wherein the logic is to send the list of channel suggestions to the companion device.

37. At least one computer accessible storage medium comprising a set of instructions which, if executed by a processor, cause a computer to:
receive a query for one or more channel suggestions;
search a database in response to the query, wherein the database is to include keyword data associated with a plurality of media devices; and
generate a list of channel suggestions based on the search.

38. The medium of claim 37, wherein the instructions, if executed, cause a computer to:
receive a first set of keyword data associated with a first media device;
receive a second set of keyword data associated with a second media device; and
add the first set of keyword data and the second set of keyword data to the database.

39. The medium of claim 37, wherein the keyword data is to include content keywords and at least one of channel identifiers, network identifiers, contextual content and timestamps.

40. The medium of claim 39, wherein the instructions, if executed, cause a computer to use at least one of the content keywords, the channel identifiers, the network identifiers, the contextual content and the timestamps to filter the list of channel suggestions.

41. The medium of claim 39, wherein the instructions, if executed, cause a computer to use at least one of the content keywords, the channel identifiers, the network identifiers, the contextual content and the timestamps to sort the list of channel suggestions.

42. The medium of claim 37, wherein the instructions, if executed, cause a computer to extract a keyword from the query.

43. The medium of claim 42, wherein the instructions, if executed, cause a computer to use the extracted keyword to search the database.

44. The medium of claim 37, wherein the query is to be received from a media device, and the instructions, if executed, cause a computer to send the list of channel suggestions to the media device.

45. The medium of claim 37, wherein the query is to be received from a companion device associated with a media device, and the instructions, if executed, cause a computer to send the list of channel suggestions to the companion device.

46. At least one computer accessible storage medium comprising a set of instructions which, if executed, cause a computer to:
identify a content keyword associated with a media device;
generate a query for one or more channel suggestions based on the content keyword; and
send the query to a cloud service.

47. The medium of claim 46, wherein the instructions, if executed, cause a computer to add at least one of the content keyword, a timestamp, a channel identifier, and a network identifier to the query.

48. The medium of claim 46, wherein the instructions, if executed, cause a computer to extract the content keyword from at least one of dynamic information and static information associated with a program.

49. The medium of claim 48, wherein the dynamic information is to include at least one of embedded text and video annotation information, and wherein the static information is to include program guide information.

50. The medium of claim 48, wherein the program is to be associated with at least one of a broadcast channel, a social networking channel, a video stream and an audio stream.

51. The medium of claim 46, wherein the instructions, if executed, cause a computer to receive a user input, wherein the content keyword is to be identified based on the user input.

52. The medium of claim 46, wherein the instructions, if executed, cause a computer to:
receive a list of channel suggestions from the cloud service;
present the list of channel suggestions to a user;
receive a user selection from the list of channel suggestions; and
navigate the media device to a channel corresponding to the user selection.

53. The medium of claim 52, wherein the list of channel suggestions is to be presented to the user via the media device.

54. The medium of claim 52, wherein the list of channel suggestions is to be presented to the user via a companion device associated with the media device.

55. A system comprising:
a network interface;
a processor; and
at least one computer accessible storage medium including a set of instructions which, if executed by the processor, cause the system to,
receive a query for one or more channel suggestions via the network interface,
search a database in response to the query, wherein the database is to include keyword data associated with a plurality of media devices, and
generate a list of channel suggestions based on the search.

56. The system of claim 55, wherein the instructions, if executed, cause the system to,
receive a first set of keyword data associated with a first media device,
receive a second set of keyword data associated with a second media device, and
add the first set of keyword data and the second set of keyword data to the database.

57. The system of claim 55, wherein the keyword data is to include content keywords and at least one of channel identifiers, network identifiers, contextual content and timestamps.

58. The system of claim 57, wherein the instructions, if executed, cause the system to use at least one of the content keywords, the channel identifiers, the network identifiers, the contextual content and the timestamps to filter the list of channel suggestions.

59. The system of claim 57, wherein the instructions, if executed, cause the system to use at least one of the content keywords, the channel identifiers, the network identifiers, the contextual content and the timestamps to sort the list of channel suggestions.

60. The system of claim 55, wherein the instructions, if executed, cause the system to extract a keyword from the query.

61. The system of claim 60, wherein the instructions, if executed, cause the system to use the extracted keyword to search the database.

62. The system of claim 55, wherein the query is to be received from a media device, and the instructions, if executed, cause the system to send the list of channel suggestions to the media device via the network interface.

63. The system of claim 55, wherein the query is to be received from a companion device associated with a media device, and the instructions, if executed, cause the system to send the list of channel suggestions to the companion device via a network interface.
